(19) United States
(12) Patent Application Publication
(10) Pub. No.: US 2012/0081364 A1
(43) Pub. Date: Apr. 5, 2012

(54) THREE-DIMENSIONAL IMAGE EDITING DEVICE AND THREE-DIMENSIONAL IMAGE EDITING METHOD

(75) Inventors: Kei YAMAJI, Tokyo (JP); Atsushi MISAWA, Tokyo (JP)

(73) Assignee: FUJIFILM CORPORATION, Tokyo (JP)

(21) Appl. No.: 13/248,278

(22) Filed: Sep. 29, 2011

(30) Foreign Application Priority Data
Sep. 30, 2010 (JP) 2010-221624
Aug. 16, 2011 (JP) 2011-178012

(51) Int. Cl. G06T 15/00

(52) U.S. Cl. 345/419

(57) ABSTRACT

When editing a three-dimensional image whose size differs when outputted from its size at the time of editing, the image producer may not be able to set an appropriate pop-out amount or a backward depth when editing. A pop-out amount range applicable to the size of a three-dimensional image as printed is displayed based on the size of the three-dimensional image as printed, and a pop-out amount range applicable to the size of a three-dimensional image as displayed is displayed based on the size of the three-dimensional image as displayed. Therefore, a three-dimensional image can be edited by noting the range of the pop-out amount applicable to the three-dimensional image as printed.

### BACKGROUND OF THE INVENTION

The present invention relates to a three-dimensional image editing device, a three-dimensional image editing method, and a three-dimensional image editing program for editing a three-dimensional image produced from a plurality of images, and a recording medium on which the program is recorded.

It is known that a human perceives depth when the left and right eye view an object from different angles and from different distances. The left and right eye view the object differently and this difference is called a parallax.

There have been hitherto proposed methods of causing a human to perceive a planar image as a three-dimensional image using the principle whereby a human perceives depth. For example, when the same object is imaged from different angles to produce images, one for the right eye and the other for the left eye (a right eye image and a left eye image), and when the right eye image and the left eye image are shown to the right eye and the left eye, respectively, with these images physically displaced rightward and leftward, the human perceives the two planar images as one three-dimensional image. Thus, a parallax is produced by displacing a right eye image and a left eye image with respect to each other. Hereinafter, the amount by which the right eye image and the left eye image are displaced with respect to each other leftward and rightward is called a displacement. When the right eye image and the left eye image are in perfect alignment, the displacement is 0. Since the human perceives depth to a degree that depends on the degree of parallax, the perceived depth (pop-out amount) of a three-dimensional image can be adjusted by adjusting the displacement between the right eye image and the left eye image.

JP 2000-78615 A describes a method whereby the right eye image and the left eye image are displayed in positions physically displaced with respect to each other on a display to adjust the parallax.

However, there is a problem that excessively increasing a displacement results in producing an excessively great strain caused to the user's eyes, and further increasing the displacement beyond human recognition capability makes depth perception impossible. It is known that a maximum allowable displacement enabling depth perception without causing an excessively great strain to the user's eyes as he/she views a three-dimensional image in a normal posture depends on the lateral length of the three-dimensional image, i.e., the length thereof in a direction in which the right eye image and the left eye image are displaced. Accordingly, a maximum allowable displacement enabling depth perception increases with the display size (lateral length) of a three-dimensional image. Since a three-dimensional image reproduces a sense of depth with a parallax between the right eye image and the left eye image and the displacement between the right eye image and the left eye image, the display size of a three-dimensional image determines a maximum allowable displacement enabling a human to perceive depth, and the maximum allowable displacement enabling depth perception determines a maximum pop-out amount up to which the user can adjust the pop-out amount on the display. In brief, the size of a three-dimensional image determines an allowable pop-out amount range.

JP 2010-45584 A discloses that the pop-out amount of a three-dimensional image also varies with the specifications of a display device such as the display resolution and the displayable area. Specifically, the above prior art literature describes a three-dimensional image correcting device capable of accurately obtaining, for example, a pop-out amount or a backward depth intended by an image producer for three-dimensional image display devices each having different specifications.

### SUMMARY OF THE INVENTION

When an image producer adjusts the pop-out amount or the backward depth of a three-dimensional image, the image producer generally adjusts the pop-out amount or the backward depth by observing the three-dimensional image displayed on a monitor provided for image editing.

However, the size of a three-dimensional image that is displayed when the image producer edits the three-dimensional image may differ from the size of the three-dimensional image outputted to an output medium (e.g., display, print) after editing. When, for example, a three-dimensional image to be printed is edited, editing including adjustment of the pop-out amount is performed by observing the three-dimensional image on the monitor. In such case, the size of the three-dimensional image displayed on the monitor for editing may differ from the size of the three-dimensional image outputted to the output medium.

Since the allowable pop-out amount range increases with the size of the three-dimensional image, when the size of the three-dimensional image as of the time of editing differs from the outputted size thereof, the allowable pop-out amount range for the size of a three-dimensional image as of the time of editing does not agree with the allowable pop-out amount range for a different size of the three-dimensional image as of the time after the three-dimensional image is outputted to, for example, a display or a printer. However, when editing a three-dimensional image of which the size changes after it is outputted from the size as of the time when it is edited, it is difficult for the image producer to set a pop-out amount considering a pop-out amount applicable to the size of the three-dimensional image outputted to, for example, a display or a printer which is different from the size as of the time of editing. When the size of an outputted three-dimensional image is larger than the size of the three-dimensional image as of the time of editing, the image producer cannot observe part of the pop-out amount of the three-dimensional image outputted to, for example, a display or a printer which is different from the size as of the time of editing.

The present invention has been made in view of the above and an object of the present invention is to provide a three-dimensional image editing device, a three-dimensional image editing method, a three-dimensional image editing program, and a recording medium on which the program is recorded, capable of setting a pop-out amount or a backward depth considering the size of a three-dimensional image outputted to, for example, a display or a printer which is different from the size of the three-dimensional image.

In order to attain the object described above, the present invention provides a three-dimensional image editing device for editing a three-dimensional image displayed on a monitor and outputting the three-dimensional image to an output medium other than the monitor, the three-dimensional image editing device comprising:

a calculation unit for calculating a first adjustment range, which is an allowable pop-out amount range for a first size of the three-dimensional image displayed on the monitor and calculating a second adjustment range, which is an allowable pop-out amount range for a second size of the three-dimensional image outputted to the output medium, and

an adjustment unit for adjusting a pop-out amount of the three-dimensional image being edited based on the first adjustment range and the second adjustment range.

Also, the three-dimensional image editing device further comprises a display control unit for causing the monitor to display the first adjustment range and the second adjustment range simultaneously.

Also, the present invention provides a three-dimensional image editing method of editing a three-dimensional image displayed on a monitor and outputting the three-dimensional image to an output medium other than the monitor, the three-dimensional image editing method comprising:

a calculation step of calculating a first adjustment range, which is an allowable pop-out amount range for a first size of the three-dimensional image displayed on the monitor and calculating a second adjustment range, which is an allowable pop-out amount range for a second size of the three-dimensional image outputted to the output medium, and

an adjustment step of adjusting a pop-out amount of the three-dimensional image being edited based on the first adjustment range and the second adjustment range.

According to the present invention, the pop-out amount of a three-dimensional image is adjusted to an appropriate pop-out amount.

### BRIEF DESCRIPTION OF DRAWINGS

FIG. 1 is a view illustrating a principle of a three-dimensional display.

FIG. 2 is a view illustrating a principle of adjusting the pop-out amount of a three-dimensional display.

FIG. 3 is a function block diagram illustrating a three-dimensional image editing device according to an embodiment 1 of the present invention.

FIG. 4 is a view illustrating an example of an editing screen displayed on a monitor.

FIG. 5 is a flowchart illustrating an example of operation of the three-dimensional image editing device according to the embodiment 1 of the present invention.

FIG. 6 illustrates a template image and a three-dimensional image where the size of a printed three-dimensional image is smaller than the size of the three-dimensional image as displayed.

FIG. 7 illustrates a template image and a three-dimensional image displayed when a pop-out amount not applicable to the size of the three-dimensional image for printing is set.

FIG. 8 illustrates a template image and a three-dimensional image where the size of a displayed three-dimensional image is smaller than the size of the three-dimensional image for printing.

FIG. 9 illustrates a template image and a three-dimensional image where a pop-out amount not applicable to the three-dimensional image as displayed is set.

FIG. 10 illustrates an example of a control method used when the size of a three-dimensional image for printing is smaller than the size of the three-dimensional image as displayed.

FIG. 11 illustrates an example of a control method used when the size of a three-dimensional image as displayed is smaller than the size of the three-dimensional image for printing.

FIG. 12 illustrates an example of a control method used when the size of a three-dimensional image as displayed is smaller than the size of the three-dimensional image for printing.

FIG. 13 illustrates an example of a control method used when the size of a three-dimensional image as displayed is smaller than the size of the three-dimensional image for printing.

FIG. 14 illustrates an example of a control method used when the size of a three-dimensional image as displayed is smaller than the size of the three-dimensional image for printing.

FIG. 15 illustrates an example of a control method of adjusting pop-out amounts of a plurality of three-dimensional images contained in one page of a photograph map collectively.

FIG. 16 illustrates an example of a three-dimensional image.

FIG. 17 illustrates a parallax map of the three-dimensional image shown in FIG. 16.

FIG. 18 illustrates a region that remains after a region having a great pop-out amount is removed from the three-dimensional image shown in FIG. 16.

### DETAILED DESCRIPTION OF THE INVENTION

The following describes the three-dimensional image editing device, the three-dimensional image editing method, the three-dimensional image editing program, and the recording medium on which the program is recorded based on a preferred embodiment illustrated in the attached drawings. Before the present invention is described, a principle of a three-dimensional display for providing a three-dimensional view will be described.

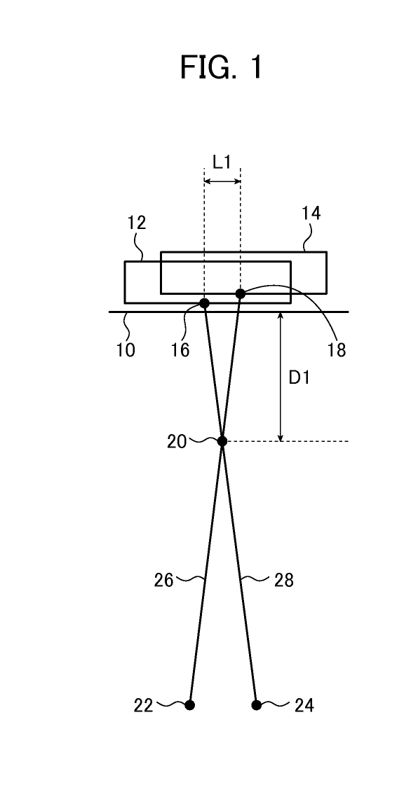

Referring to FIG. 1, a description will be made of an example of a three-dimensional display for providing a three-dimensional view by showing different images to the left and right eye. FIG. 1 is a view describing a three-dimensional display as seen from above and lines of sight to explain a principle of a three-dimensional display. A three-dimensional display 10 displays a right eye image 12 and a left eye image 14. The right eye image 12 is displayed only to the right eye viewing from a point 24. The left eye image 14 is displayed only to the left eye viewing from a point 22.

Now consider a case where a point 16 representing a subject exists on the right eye image 12, and a point 18 representing the same subject exists on the left eye image 14. Hereinafter, points in the right eye image and the left eye image representing the same subject such as the point 16 and the point 18 will be called corresponding points. The three-dimensional display 10 displays the right eye image 12 and the left eye image 14 that are physically displaced by a distance of L1 between the point 16 and the point 18 in the left and the right direction. Note that the right eye image 12 and the left eye image 14 are displayed in reality on the three-dimensional display 10 and thus the three-dimensional display 10, the right eye image 12, and the left eye image 14 are not displaced with respect to each other in the vertical direction as seen in the drawing, but for the sake of clarity, the drawing shows the three-dimensional display 10, the right eye image 12, and the left eye image 14 displaced in the vertical direction as seen in the drawing. Note also that the drawing shows the right eye image 12 and the left eye image 14 as having a thickness in the vertical direction as seen in the drawing, but these images do not have the thickness because in reality these images are displayed on the three-dimensional display 10.

A human viewing the three-dimensional display 10 providing such a display perceives the subject represented by the point 16 and the point 18 to be located at a position shown by a point 20 where a line of sight 26 of the left eye viewing the point 18 and a line of sight 28 of the right eye viewing the point 16 intersect. In this case, the subject represented by the point 16 and the point 18 is perceived to be projecting from the three-dimensional display 10 by a distance of D1 between the three-dimensional display 10 and the point 20. The pop-out amount in this case is the distance D1 between the three-dimensional display 10 and the point 20. The three-dimensional display 10 causes the human viewer to perceive the subject to be projecting from the three-dimensional display 10 due to the displacement between the right eye image 12 and the left eye image 14 in the left and right direction as seen in the drawing and the parallax between the right eye image 12 and the left eye image 14. The same principle may be applied to produce a sense of depth on the farther side of a three-dimensional image (backward depth) and thereby cause the human to perceive an object to be on the farther side of the three-dimensional display 10. Hereinafter, descriptions will be made solely of the pop-out amount as opposed to the backward depth for ease of explanation. Since the human perceives depth due to parallax, the pop-out amount of a three-dimensional image can be adjusted by adjusting the displacement between the right eye image and the left eye image to adjust the degree of parallax (amount of parallax).

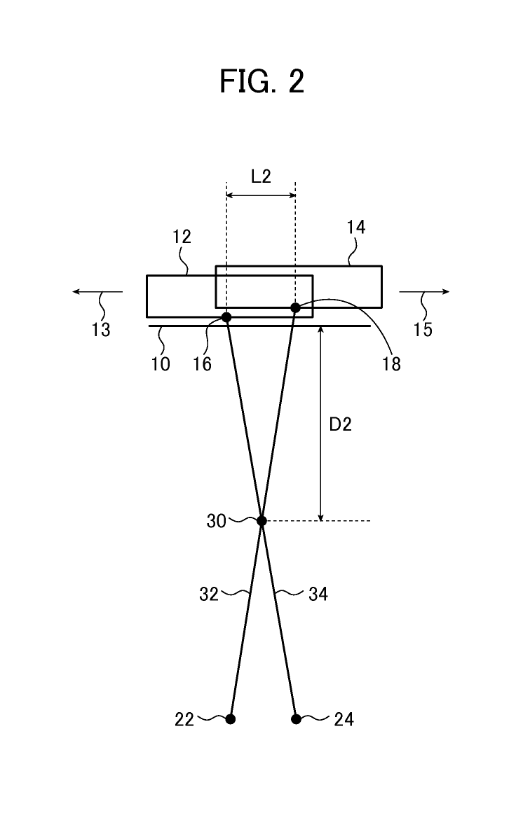

FIG. 2 is a view illustrating a case where the displacement between the right eye image 12 and the left eye image 14 is changed in the three-dimensional display 10 to change the pop-out amount of the image. Suppose that the right eye image 12 is moved leftward (in a direction indicated by an arrow 13), and the left eye image 14 is moved rightward (in a direction indicated by an arrow 15), to display the right eye image 12 and the left eye image 14 with a distance L2 (>L1) between the point 16 and the point 18. In such a case, the human perceives the subject to be located at a position shown by a point 30 where a line of sight 32 of the left eye viewing the point 18 and a line of sight 34 of the right eye viewing the point 16 intersect. Since the distance between the three-dimensional display 10 and the point 30 is D2 (>D1), the pop-out amount in this case is D2. Thus, the pop-out amount by the human can be changed by changing the displacement.

The maximum allowable displacement enabling depth perception increases with the display size (length in the lateral direction) of a three-dimensional image; the pop-out amount of the three-dimensional image increases with the maximum allowable displacement enabling depth perception. Accordingly, when the pop-out amount of a three-dimensional image is set, the size of the three-dimensional image needs to be considered.

Since the pop-out amount depends on the parallax between the right eye image and the left eye image, the pop-out amount varies for the same three-dimensional image depending on the position of the subject in the depth direction of the image. For clarity, the pop-out amount in the following description denotes the pop-out amount for corresponding points farthest displaced when the displacement between the right eye image and the left eye image is 0, i.e., corresponding points on a subject located closest to the viewer.

That is, since the right eye image and the left eye image are images acquired by imaging the same subject from different angles, there originally is a parallax between a shot image for the right eye and a shot image for the left eye even when the physical displacement between the right eye image and the left eye image displayed on a display medium such as a display device is 0. Making the displacement between the right eye image and the left eye image 0 does not place the right eye image and the left eye image in perfect alignment, leaving the corresponding points representing the same subject still displaced from each other, which produces a parallax between the original shot image for the right eye and the original shot image for the left eye.

Accordingly, when the right eye image and the left eye image are displayed, one physically displaced with regard to the other in the left-and-right direction, the magnitude of the displacement of the corresponding points representing the same subject in the right eye image and the left eye image may be expressed as the sum of the physical displacement and the magnitude of the displacement between the corresponding points due to the parallax originally existing between the shot image for the right eye and the shot image for the left eye. Since, as described above, the physical displacement between the right eye image and the left eye image produces a parallax, the magnitude of the displacement between the right eye image and the left eye image, i.e., the distance between the corresponding points, is the magnitude of a parallax sensed by the human and may be said to denote a degree of parallax. Such degree of parallax may also be referred to, for example, as parallactic angle or parallax amount.

On the other hand, since the pop-out amount of the three-dimensional image depends on the distance between the corresponding points on the right eye image and the left eye image as described above, the pop-out amount may be said to depend on the degree of the parallax expressed by this distance between the corresponding points.

The shot image for the right eye and the shot image for the left eye described above may contain different, various subjects in the depth direction and, as is known, the displacement between the corresponding points on a subject located farther from the human viewer is smaller, while the displacement between the corresponding points on a subject located closer to the human viewer is greater. This also applies when the physical displacement between the right eye image and the left eye image is 0. Therefore, to be exact, the displacement between the corresponding points on a subject varies depending on the individual subjects contained in a shot image. However, since a shot image typically shows a major subject in the foreground, it is often preferable to use a subject located in the foreground as a reference.

Thus, according to the invention, the pop-out amount of a three-dimensional image is determined, as a reference, as the pop-out amount of the corresponding points on a subject in the foreground when the displacement between the right eye image and the left eye image is 0.

However, there are cases where it is difficult to set a pop-out amount considering the size of a three-dimensional image. Such cases include one where a photograph album is edited. A photograph album is produced by printing three-dimensional images for which pop-out amounts are set by a person who places the order and contains images reproducing apparent depth to the viewer. Since adjusting the pop-out amount of an already printed three-dimensional image is impossible, the person who places the order sets pop-out amounts of three-dimensional images to be printed by observing the three-dimensional images displayed on a monitor. In this case, the size of a three-dimensional image displayed on the monitor often disagrees with the size of the three-dimensional image for printing.

Generally, the person who places the order expects the pop-out amount that is set for the three-dimensional image displayed on the monitor to be reproduced as it is in the three-dimensional image as printed. In fact, however, if the size of a three-dimensional image displayed on the monitor differs from the size of a printed three-dimensional image, the allowable pop-out amount ranges applicable to the respective three-dimensional images disagree. Thus, problems may arise that a pop-out amount set for a three-dimensional image displayed on a monitor cannot be applied to a three-dimensional image to be printed, or a pop-out amount applicable to a printed three-dimensional image cannot be observed in a three-dimensional image displayed on the monitor. However, it is difficult for a person who places an order to set a pop-out amount considering the size of a three-dimensional image to be printed.

The inventors of the present invention conducted an intensive study to solve the above problems and found that a pop-out amount and a backward depth considering the size with which a three-dimensional image is outputted to an output medium can be set by adjusting the pop-out amount of a three-dimensional image being edited based on two kinds of previously calculated adjustment ranges, one being an allowable pop-out amount range for the size of a three-dimensional image displayed on a monitor during editing, the other being an allowable pop-out amount range for the size of the three-dimensional image outputted to an output medium, and achieved the invention described below.

Now, an embodiment of the present invention will be described below based on the appended drawings.

### Embodiment 1

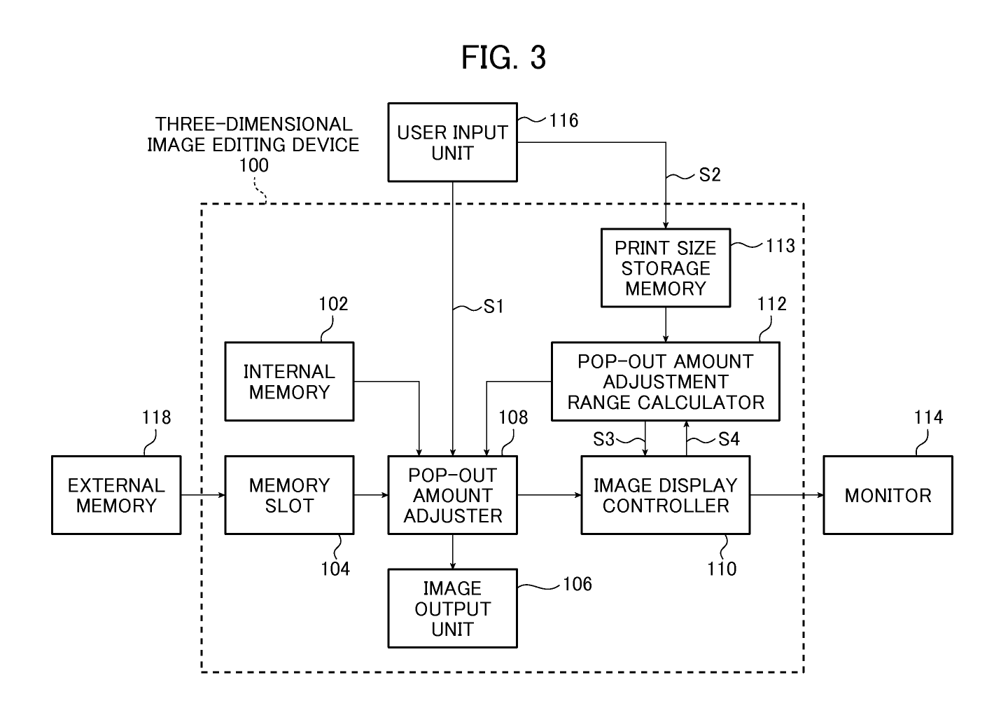

FIG. 3 is a function block diagram illustrating major components of a three-dimensional image editing device 100 according to the embodiment 1 of the present invention. Now, a case will be described by way of example where a photograph album is produced by printing photographs that allow depth perception. The three-dimensional image editing device 100 comprises an internal memory 102, a memory slot 104, an image output unit 106, a pop-out amount adjuster 108, an image display controller 110, a pop-out amount adjustment range calculator 112, and a print size storage memory 113. In use, the three-dimensional image editing device 100 is electrically connected to a monitor 114, a user input unit 116, and an external memory 118. The three-dimensional image editing device 100 also comprises a controller such as a CPU, not shown, for controlling the whole three-dimensional image editing device 100.

The monitor 114 is capable of three-dimensionally displaying a right eye image and a left eye image. The three-dimensional display may be of any known type. Examples of the type of the three-dimensional display include parallax division type such as parallax barrier type and lenticular lens type; and image separating type using special eyeglasses such as color filter type, polarization filter type, and liquid crystal shutter type. The monitor 114 permits selection between three-dimensional display and planar display on the display screen.

The user input unit 116 is provided for the user to make entries and may be, for example, a mouse and a keyboard.

The internal memory 102 stores left eye images and right eye images for producing three-dimensional images. The internal memory 102 may store information including data, parameters, and characteristics required for operation of the three-dimensional image editing device 100 in addition to image data of left eye images and right eye images such as, for example, other image data and conversion characteristics for setting a pop-out amount applicable to an image size.

The memory slot 104 electrically connects the three-dimensional image editing device 100 and the external memory 118. When the memory slot 104 is connected with the external memory 118, the three-dimensional image editing device 100 can read out data such as an image stored in the external memory 118. The external memory 118 may also store image data and above various kinds of information.

The image output unit 106 outputs a three-dimensional image to the outside; it converts a three-dimensional image signal into output image data, which is outputted to an external output device (not shown) and comprises an external interface for connection to an external output device. When connected, for example, to a printer, not shown, the image output unit 106 causes the printer to print a three-dimensional image and, when connected to a display device, not shown, causes the display device to display a three-dimensional image.

The pop-out amount adjuster 108 changes the displacement between the right eye image and the left eye image outputted from the internal memory 102 or the external memory 118 and changes the degree of parallax to adjust the pop-out amount of the three-dimensional image. As described above, the adjustment of the right eye image and the left eye image is made using as a reference the distance between the corresponding points farthest apart from each other when the right eye image and the left eye image are superposed in precise alignment (the corresponding points on a subject located in the foreground in the image). In response to the setting of a pop-out amount of a three-dimensional image entered by the user through the user input unit 116, the pop-out amount adjuster 108 adjusts the pop-out amount of the three-dimensional image according to the pop-out amount adjusting signal (S1) outputted from the user input unit 116.

In response to the setting of a pop-out amount for a print size entered by the user through the user input unit 116, the print size storage memory 113 receives a print size designation signal (S2) outputted from the user input unit 116 and stores the size of a photograph album to be printed and the size of the three-dimensional images contained in the photograph album.

The pop-out amount adjustment range calculator 112 calculates a pop-out amount range within which the pop-out amount can be adjusted by the user for the size of a three-dimensional image to be printed which is stored in the print size storage memory 113 (referred to below as allowable pop-out amount range) and outputs the calculation result to the pop-out amount adjuster 108 and the image display controller 110. The allowable pop-out amount range refers to a range of pop-out amount in which the user can perceive depth in a three-dimensional image. The allowable pop-out amount range varies with the size of a three-dimensional image. For example, the allowable pop-out amount range may be defined as a range of a pop-out amount that can be obtained by a displacement between the right eye image and the left eye image from displacement 0 to a displacement of 5% of the length in the lateral (left and right) direction of a three-dimensional image. The pop-out amount adjustment range calculator 112 calculates the allowable pop-out amount range for the display size of a three-dimensional image outputted from the image display controller 110 and outputs the allowable pop-out amount range to the image display controller 110.

The image display controller 110 outputs image data to the monitor 114 after conversion thereof into a format as required by the monitor 114. Further, the image display controller 110 causes the monitor 114 to display an allowable pop-out amount ranges (S3) for a three-dimensional image as displayed and for the three-dimensional image as printed, both outputted from the pop-out amount adjustment range calculator 112. Further, the image display controller 110 changes the display size of a three-dimensional image and outputs information (S4) on the changed display size of the three-dimensional image to the pop-out amount adjustment range calculator 112. Further, the image display controller 110 performs various controls necessary to display a three-dimensional image on the display screen of the monitor 114 such as a control of a layout of a three-dimensional image and GUIs (graphical user interfaces) displayed on the display screen and a control of the display screen.

Upon receiving the signal (S4) indicating a change in display size of a three-dimensional image, the pop-out amount adjustment range calculator 112 calculates an allowable pop-out amount range for the changed display size of the three-dimensional image and outputs the allowable pop-out amount range to the image display controller 110.

Thus, the three-dimensional image editing device 100 causes the monitor 114 to display allowable pop-out amount ranges for the size in which a three-dimensional image is printed and for the size in which a three-dimensional image is displayed.

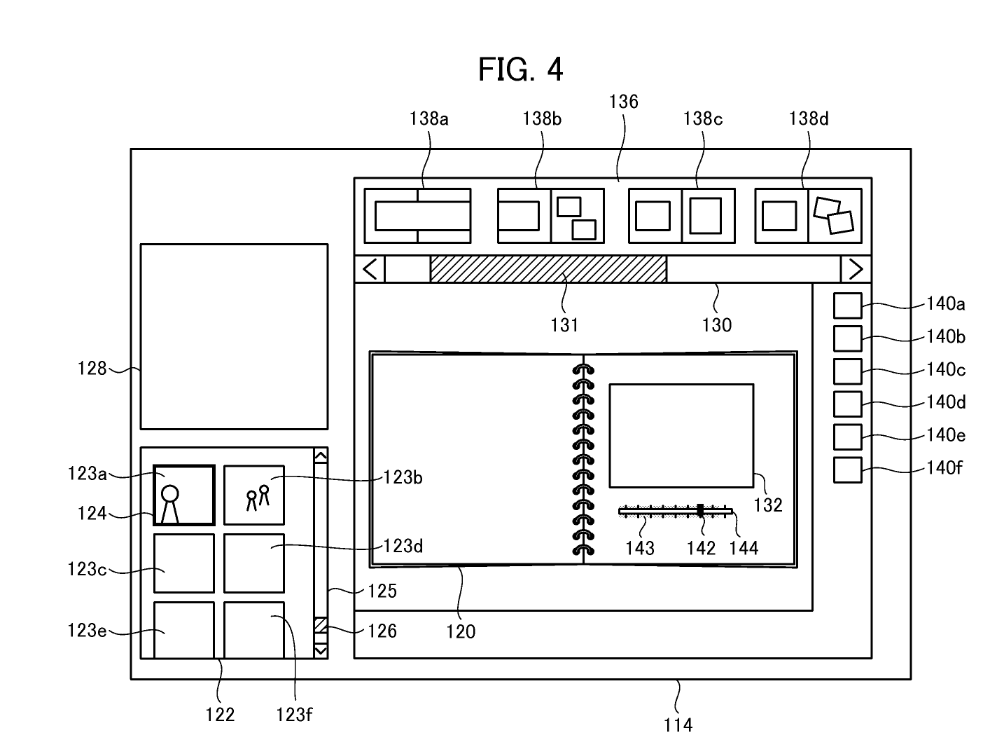

FIG. 4 illustrates an example of an editing screen displayed on the monitor 114. This editing screen is displayed in the process of producing a photograph album where a three-dimensional image is placed in a template image.

The monitor 114 shows at its center a template image 120 simulating a book representing a photograph album. The user can determine a layout of images to be arranged in the photograph album by positioning images within a region defined by the template image 120 using, for example, a mouse of the user input unit 116. In FIG. 4, a three-dimensional image 132 is disposed within the region defined by the template image 120. The three-dimensional image 132 is displayed three-dimensionally.

In an image display region 122 provided at the lower left of the monitor 114, six three-dimensional images 123a to 123f to be disposed in the template image 120 are displayed three-dimensionally. The three-dimensional images 123a to 123f are images stored in the internal memory 102 or the external memory 118. The the internal memory 102 or the external memory 118 stores data of the three-dimensional images so that the right eye image, the left eye image, and tag information are associated with each other. The tag information contains the pop-out amounts of the right eye image and the left eye image. The tag information stored contains the displacement between a right eye image and a left eye image. Therefore, when the three-dimensional image corresponding to the right eye image and the left eye image is displayed on the monitor 114, the pop-out amount adjuster 108 may be adapted to obtain a pop-out amount corresponding to the stored displacement. The three-dimensional image displayed in the image display region 122 is displayed three-dimensionally with a previously stored pop-out amount.

The user uses, for example, the mouse of the user input unit 116 to drag the images displayed in the image display region 122 and drop them in the template image 120 to determine the layout in the photograph album. A three-dimensional image dropped in the template image 120 is automatically adjusted to a size that suits the size of the template image 120. In this case, the pop-out amount of the three-dimensional image is also automatically adjusted according to a predetermined conversion characteristic for determining a pop-out amount for a given image size. When the conversion characteristic for determining a pop-out amount for a given image size is set such that, for example, the pop-out amount increasingly decreases as the image size grows larger, the strain caused to the user's eyes can be reduced.

On the right side of the image display region 122, a scroll bar 125 is provided. The user uses, for example, the mouse to drag the position of the knob 126 provided in the scroll bar 125 up and down to scroll the images displayed in the image display region 122. This operation allows images stored in the internal memory 102 or the external memory 118 and not displayed in the image display region 122 to be displayed in the image display region 122.

Above the image display region 122, a display region 128 is provided. The display region 128 shows a folder hierarchy structure. The folder hierarchy structure shown in the display region 128 enables the user to know which folder contains the images displayed in the image display region 122. By selecting another folder displayed in the display region 128, the user can cause the images stored in another folder to be displayed in the image display region 122.

Further, the display region 128 can display an image selected from the image display region 122 on an enlarged scale with a cursor 124 by using, for example, the mouse. The position of the cursor 124 can be freely moved by the user with the mouse or the like. With an image shown enlarged, the user can observe the image in detail. When necessary, an image selected by the user from among the images in the template image 120 can be shown enlarged in the display region 128.

There is displayed above the template image 120 a region showing size-reduced images arranged in the individual pages constituting the photograph album, i.e., a reduced page display region 136. The reduced page display region 136 shows images in size-reduced pages 138a to 138d each in double-page spread.

Beneath the reduced page display region 136, a scroll bar 130 is reduced. The user can cause the pages now outside the reduced page display region 136 to be displayed in the reduced page display region 136 by dragging a knob 131 provided in the scroll bar 130 in the left-and-right direction as seen in the drawing using the mouse or the like.

On the right side of the template image 120 are provided six editing buttons 140a to 140f. The editing buttons 140a to 140f are each assigned editing functions. The user pushes the editing buttons using the mouse or the like to edit images arranged in the photograph album. The editing button 140b is assigned, for example, an image size change function. The user pushes the editing button 140b with a mouse, for example, to select an image size change mode. Other editing functions include, for example, merging characters into the template image 120, removal of an image from the template image 120, and production of a conversion characteristic for automatically setting a pop-out amount for a three-dimensional image.

The editing button 140a is assigned an image pop-out amount adjustment function. FIG. 4 illustrates an example of the template image 120 that is displayed when the editing button 140a is pushed to select a pop-out amount adjustment mode. In the pop-out amount adjustment mode, a scroll bar comprising a knob 142 and a bar 144 are displayed beneath the three-dimensional image 132 placed in the template image 120 for setting a pop-out amount of the three-dimensional image 132. The length of the bar 144 shows an allowable pop-out amount range for the display size of the three-dimensional image 132. Beneath the three-dimensional image 132 is displayed a region 143, shown as a shaded area in the drawing, together with the knob 142 and the bar 144 by superposition to indicate the allowable pop-out amount range for the size of a three-dimensional image for printing. The user uses, for example, a mouse to drag the knob 142 left and right to adjust the pop-out amount of the three-dimensional image 132. The user can move the knob 142 left and right within at least one of the ranges of the bar 144 and the region 143. Specifically, the user may not set a pop-out amount that cannot be adjusted for either of a three-dimensional image as printed and the three-dimensional image displayed on the monitor 114. The region 143 indicating an allowable pop-out amount range for the print size of the three-dimensional image 132 makes it possible to determine whether the pop-out amount set for the three-dimensional image 132 as displayed is also applicable to the size thereof for printing.

Through the above processing including arrangement, size change, and pop-out amount adjustment of three-dimensional images, the user determines the layout of the photograph album.

Upon termination of photograph album editing, a photograph album is printed by, for example, a printer connected to the three-dimensional image editing device 100 with layouts and pop-out amounts as set by the user.

The pop-out amount of a three-dimensional image is adjusted in the pop-out amount adjuster 108 by adjusting the displacement between the right eye image and the left eye image constituting a three-dimensional image. Table 1 shows examples of maximum allowable displacements for sizes of a three-dimensional image for display on the monitor and for printing.

TABLE 1

| One page of photograph album | | 3D image | | Max. displacement | |
|---|---|---|---|---|---|
| Monitor | Print | Monitor | Print | Monitor | Print |
| 150 × 150 | 125 × 125 | 15 × 15 | 12.5 × 12.5 | 0.75 | 0.625 |
| 150 × 150 | 210 × 210 | 15 × 15 | 21 × 21 | 0.75 | 1.05 |

(unit: mm)

A maximum allowable displacement may be defined by a ratio of the displacement to the lateral length of a three-dimensional image. For example, when a maximum allowable displacement is 5% of the lateral length of a three-dimensional image, the displacement of a three-dimensional image measuring 12.5 mm×12.5 mm when printed is adjustable to a maximum of 0.625 mm. The displacement of a three-dimensional image measuring 21 mm×21 mm when printed is adjustable to a maximum of 105 mm. The displacement of a three-dimensional image measuring 15 mm×15 mm when displayed on the monitor 114 is adjustable to a maximum of 0.75 mm.

As it appears from Table 1, when the size of a three-dimensional image as displayed on the monitor 114 is larger than the size of the three-dimensional image for printing, the allowable pop-out amount range for the three-dimensional image displayed on the monitor 114 is wider than the allowable pop-out amount range for the three-dimensional image for printing. For example, even when the pop-out amount of a three-dimensional image displayed on the monitor 114 is set to a maximum, that is, when the displacement is set to 0.75 mm, that pop-out amount is inapplicable to the print size of the three-dimensional image. Therefore, there may arise a problem that a three-dimensional image is not printed with a pop-out amount set by the user observing the three-dimensional image on the monitor 114.

When the size of a three-dimensional image for display on the monitor 114 is smaller than the size of the three-dimensional image for printing, the maximum allowable displacement for the three-dimensional image as displayed on the monitor 114 is smaller than the maximum allowable displacement applicable to the size with which the three-dimensional image is printed. Accordingly, there are cases where a pop-out amount that is applicable to the size of a three-dimensional image for printing is inapplicable to the size of the three-dimensional image for display on the monitor 114. Therefore, there arises a problem that the user cannot view on the monitor 114 such a range that is inside of the allowable pop-out amount range for the size of a three-dimensional image for printing but outside of the allowable pop-out amount range for the size of the three-dimensional image displayed on the monitor 114.

Thus, the three-dimensional image editing device 100 of the invention enables the user to set a pop-out amount of a three-dimensional image within an appropriate range by calculating an allowable pop-out amount range for a print size of the three-dimensional image and an allowable pop-out amount range for a display size of the three-dimensional image.

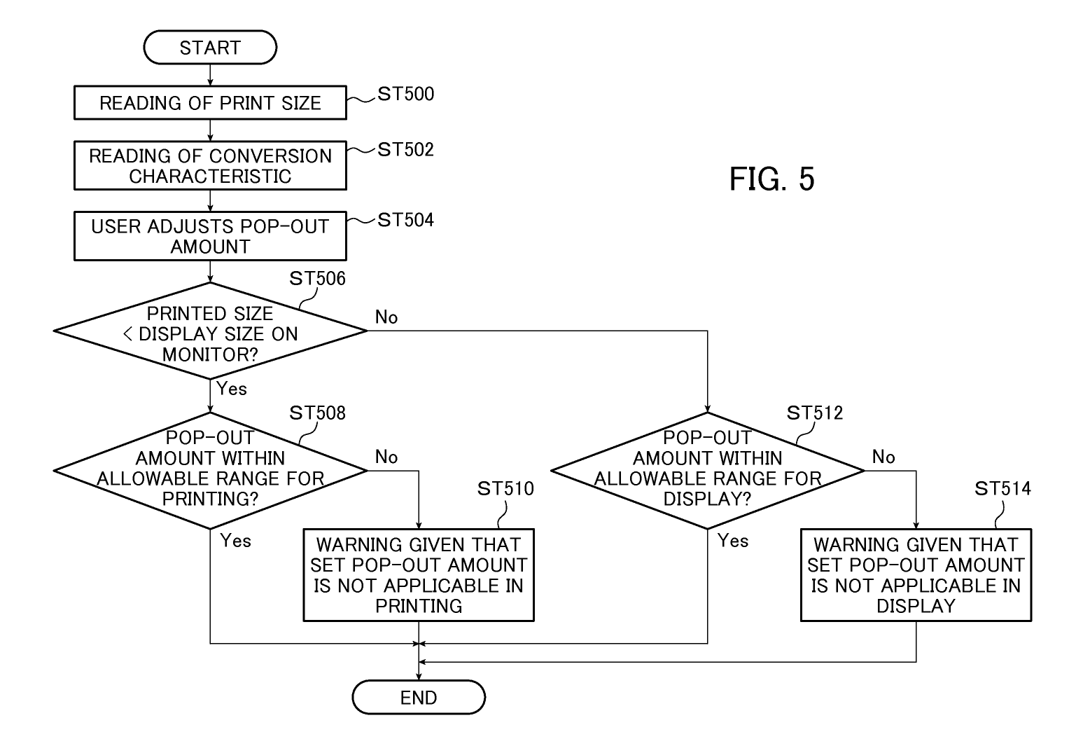

FIG. 5 is a flowchart illustrating an example of the operation of the three-dimensional image editing device 100 and the three-dimensional image editing method of the invention.

The three-dimensional image editing device 100 varies the adjustment of the pop-out amount depending on which of the size of a three-dimensional image displayed on the monitor 114 and the size of the three-dimensional image for printing is larger.

First, the print size designated by the user via the user input unit 116 in step ST500 is read from the print size storage memory 113 for the pop-out amount adjustment range calculator 112 to calculate an allowable pop-out amount range for the print size of a three-dimensional image. The pop-out amount adjuster 108 automatically adjusts the pop-out amount of the three-dimensional image placed in the template image 120 by reading a conversion characteristic from, for example, the internal memory 102 in step ST502, and the pop-out amount adjustment range calculator 112 calculates an allowable pop-out amount range for a display size of the three-dimensional image.

In step ST504, the user adjusts the pop-out amount from the user input unit 116. In step ST506, a judgment is made as to whether the print size of the image is smaller than the display size on a PC (personal computer), and when the print size of the image is smaller, the procedure proceeds to step ST508.

In step ST508, a judgment is made as to whether the adjusted pop-out amount is within the allowable pop-out amount range (allowable range) for the print size of the three-dimensional image.

When the adjusted pop-out amount is judged to be within the allowable range for printing in step ST508, editing of the three-dimensional image is terminated.

When the adjusted pop-out amount is judged to be outside of the allowable range for printing in step ST508, a judgment is made that the set pop-out amount is not applicable for printing, and the procedure proceeds to step ST510 to cause the monitor 114 to display a warning that the set pop-out amount is not applicable to the size of the three-dimensional image for printing, terminating the editing of the three-dimensional image.

When the size of the image for display on the PC is judged to be smaller than the print size thereof in step ST506, the procedure proceeds to step ST512.

In step ST512 a judgment is made as to whether the adjusted pop-out amount is within the allowable range for display; when the adjusted pop-out amount is within the allowable pop-out amount range for the size of the three-dimensional image for display on the monitor 114, editing of the three-dimensional image is terminated.

When the adjusted pop-out amount is judged to be outside of the allowable range for display on the monitor 114 in step ST512, a judgment is made that the pop-out amount of the three-dimensional image as printed will exceed that applied to the three-dimensional image displayed on the monitor 114, and the procedure proceeds to step ST514 to cause the monitor 114 to display a warning that the set pop-out amount is inapplicable in the monitor 114, terminating the editing of the three-dimensional image.

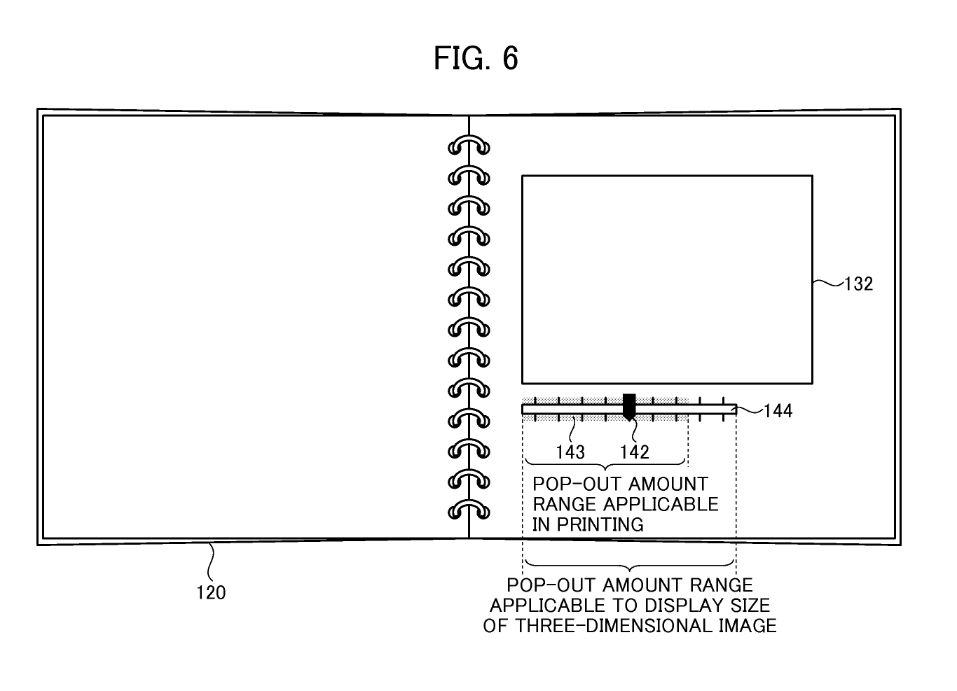

FIG. 6 illustrates the template image 120 and the three-dimensional image 132 in a pop-out amount adjustment mode. FIG. 6 shows only the template image 120 and the three-dimensional image 132 placed in the template image 120 from the display screen of the monitor 114. Hereinafter, unless otherwise specified, the drawings illustrating the template image 120 and the three-dimensional images displayed in the template image 120 thus show a part of the whole image displayed on the display screen of the monitor 114.

Push of the editing button 140a causes a scroll bar composed of a knob 142 and a scaled bar 144 to be shown beneath the three-dimensional image 132 disposed in the template image 120. The longitudinal length of the bar 144 (referred to simply as length below) shows an allowable pop-out amount range for the size of the three-dimensional image 132. Since the allowable pop-out amount range broadens as the size of the three-dimensional image increases, the length of the bar 144 grows longer as the size of the three-dimensional image increases. The user uses the mouse or the like to move the knob 142 in the left-and-right direction as seen in the drawing to adjust the pop-out amount. As the knob 142 is moved leftward, the pop-out amount of the three-dimensional image 132 decreases; when the knob 142 is moved to the left end of the bar 144, the pop-out amount is set to 0. Then, the three-dimensional image 132 is not displayed three-dimensionally, and the right eye image or the left eye image is displayed in the position of the three-dimensional image 132. As the knob 142 is moved rightward, the pop-out amount of the three-dimensional image 132 increases; when the knob 142 is moved to the right end of the bar 144, the pop-out amount is set to a maximum.

Beneath the three-dimensional image 132 is displayed a region 143, shown as a shaded area in the drawing, together with the bar 144 by superposition to indicate the allowable pop-out amount range for the size of a three-dimensional image for printing. The longitudinal length of the region 143 (referred to simply as length below) shows an allowable pop-out amount range for a print size of a three-dimensional image. The length of the region 143 varies with the print size of a three-dimensional image; the length of the region 143 grows longer as the print size of a three-dimensional image increases.

The allowable pop-out amount range for the print size of a three-dimensional image overlaps the allowable pop-out amount range for the display size of the three-dimensional image; since a pop-out amount of 0 is settable for both ranges, the left ends of the superposed region 143 and bar 144 meet.

FIG. 6 illustrates a template image 120 and the three-dimensional image 132 displayed when the size of that three-dimensional image as printed is smaller than the size of the three-dimensional image 132 displayed on the monitor 114. In this case, the allowable pop-out amount range for the display size of the three-dimensional image 132 is wider than that for the print size thereof. Therefore, the bar 144 is displayed with a longer length than the region 143.

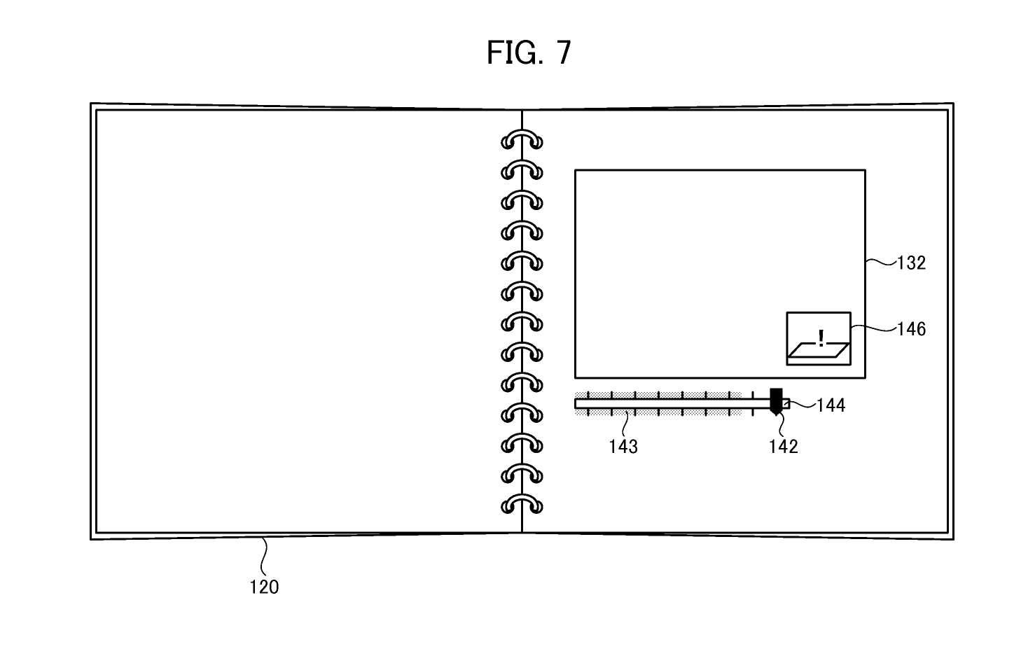

FIG. 7 illustrates an example of the template image 120 and the three-dimensional image 132 displayed when the size of that three-dimensional image as printed is smaller than the three-dimensional image 132 displayed on the monitor 114 and when a set pop-out amount is applicable to the three-dimensional image 132 displayed on the monitor 114 and inapplicable to the size of the three-dimensional image for printing.

In FIG. 7, the knob 142 is on the bar 144 and outside of the region 143. The bar 144 shows the allowable pop-out amount range for the size of the three-dimensional image 132 as displayed on the monitor 114; the region 143 shows the allowable pop-out amount range for the size of the three-dimensional image for printing. Therefore, the pop-out amount set by the knob 142 in FIG. 7 is applicable to the size of the three-dimensional image 132 displayed on the monitor 114 and inapplicable to the size of the three-dimensional image for printing.

In this case, since the pop-out amount of the three-dimensional image 132 displayed on the monitor 114 is inapplicable to the three-dimensional image as printed, a warning mark 146 is displayed at the bottom right of the three-dimensional image 132. The warning mark 146 alerts the user to note that the three-dimensional image will be printed with a pop-out amount that is smaller than that of the image displayed on the monitor 114.

When the user gives an instruction for printing a three-dimensional image knowing that it will be printed with a pop-out amount smaller than that of the three-dimensional image 132 displayed on the monitor 114, the three-dimensional image is printed with a maximum possible pop-out amount for the size of that three-dimensional image with which it is to be printed.

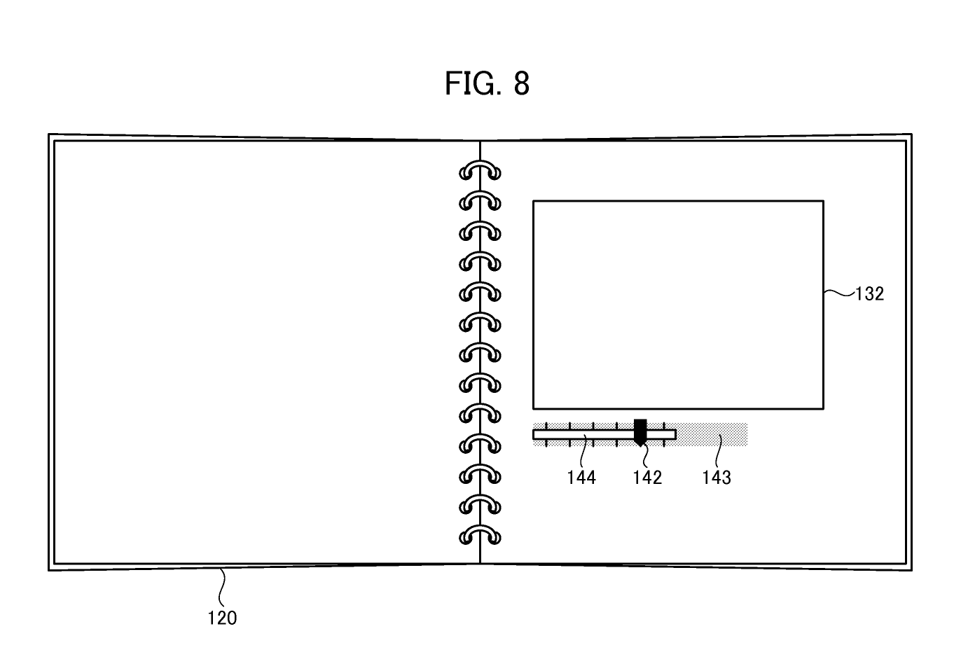

FIG. 8 illustrates the template image 120 and the three-dimensional image 132 displayed when the size of that three-dimensional image as printed is larger than the size of the three-dimensional image 132 displayed on the monitor 114 In this case, the allowable pop-out amount range for the three-dimensional image as printed is wider. Therefore, the region 143 is displayed with a longer length than the bar 144.

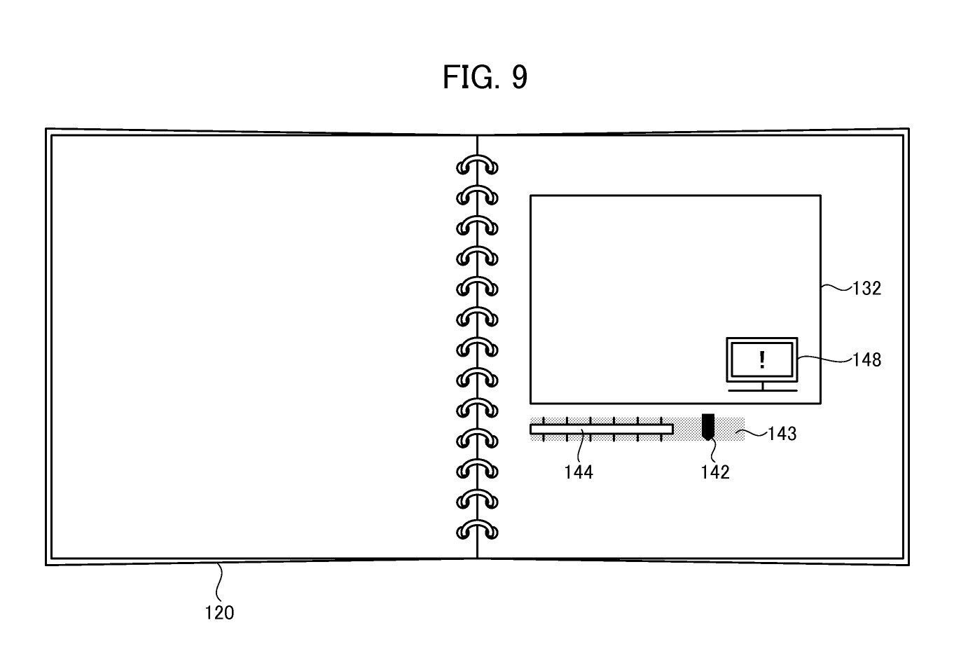

FIG. 9 illustrates an example of the template image 120 and the three-dimensional image 132 that are displayed when the size of that three-dimensional image as printed is larger than the size of the three-dimensional image 132 displayed on the monitor 114 and when a set pop-out amount is applicable to the three-dimensional image as printed and inapplicable to the three-dimensional image 132 displayed on the monitor 114.

In FIG. 9, the knob 142 is positioned on the outside of the bar 144 and within the region 143. The bar 144 shows the allowable pop-out amount range for the size of the three-dimensional image 132 displayed on the monitor 114; the region 143 shows the allowable pop-out amount range for the size of the three-dimensional image for printing. Therefore, the pop-out amount set by the knob 142 in FIG. 9 is inapplicable to the size of the three-dimensional image 132 to be displayed on the monitor 114 and applicable to the size of the three-dimensional image for printing.

In this case, since the pop-out amount of the three-dimensional image as printed is inapplicable to the three-dimensional image 132 displayed on the monitor 114, a warning mark 148 is displayed at the bottom right of the three-dimensional image 132. The warning mark 148 is displayed to alert the user to note that a three-dimensional image will be printed with a pop-out amount greater than that of the three-dimensional image now displayed on the monitor 114 or, in other words, that the pop-out amount of the three-dimensional image to be printed is not correctly represented on the monitor 114.

When the user gives an instruction for printing a three-dimensional image knowing that it will be printed with a pop-out amount greater than that of the three-dimensional image displayed on the monitor 114, the three-dimensional image is printed with a pop-out amount indicated by the position of the knob 142.

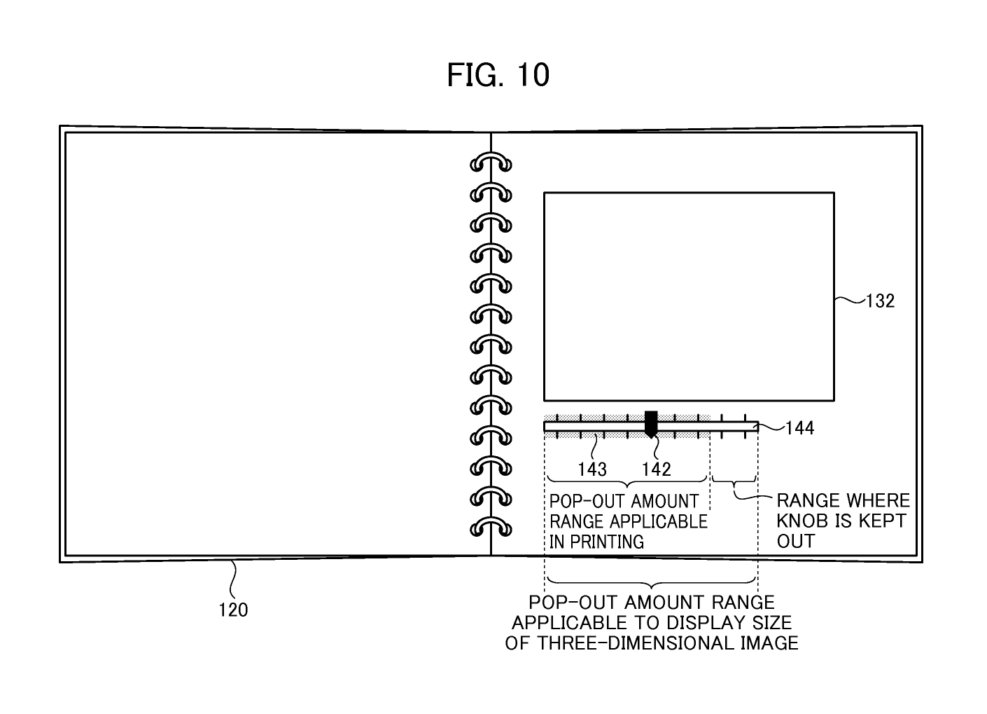

FIG. 10 illustrates another control method used when the size of the three-dimensional image 132 displayed on the monitor 114 is larger than the size of the three-dimensional image as printed.

In this case, the control is so effected that even when the user moves the knob 142 with, for example, a mouse to a position within an allowable pop-out amount range applicable to the size of the three-dimensional image 132 displayed on the monitor 114 and outside of an allowable pop-out amount range applicable to the size of the three-dimensional image to be printed, the knob 142 is automatically moved to select a maxim of the allowable pop-out amount range for the size of the three-dimensional image for printing. Specifically, even when the user moves the knob 142 to the right end of the bar 144, the three-dimensional image 132 is displayed with the uppermost limit of the allowable pop-out amount range for the size of the three-dimensional image for printing. While, in this case, the knob 142 is moved to the uppermost limit of the allowable pop-out amount range for the size of the three-dimensional image as printed, the knob 142 may be adapted so that it cannot be moved to a position outside of the allowable pop-out amount range for the size of the three-dimensional image as printed.

As described above, where the print size of a three-dimensional image is smaller than the displayed size of a three-dimensional image, when the pop-out amount of the three-dimensional image 132 displayed on the monitor 114 is automatically adjusted to the allowable pop-out amount range for the three-dimensional image as printed, i.e., to within a range common to the allowable pop-out amount range for the size of a three-dimensional image as displayed and the allowable pop-out amount range for the size of the three-dimensional image for printing, the pop-amount of the three-dimensional image 132 displayed on the monitor 114 never disagrees with the pop-amount of the three-dimensional image as printed. Thus, the user does not feel discomfort when viewing a printed three-dimensional image.

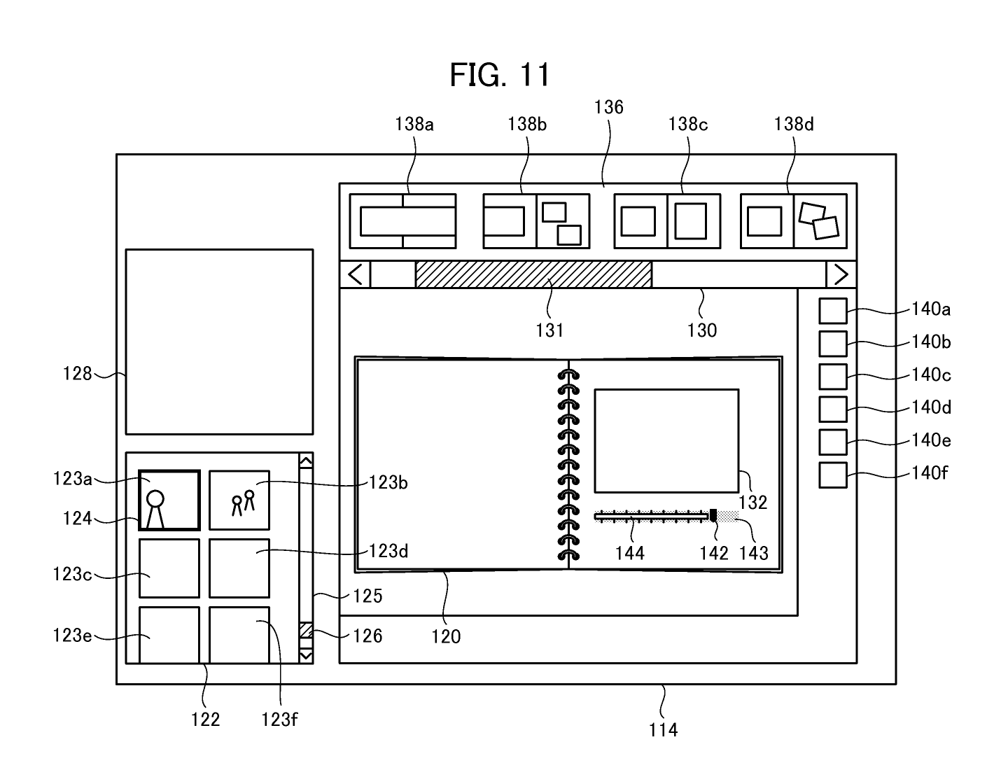

FIG. 11 illustrates another control method used when the size of the three-dimensional image 132 displayed on the monitor 114 is smaller than the size of the three-dimensional image as printed. FIG. 11 illustrates a photograph album editing screen in the pop-out amount adjustment mode displayed on the monitor 114. The same items as in FIG. 4 share the same reference characters and descriptions thereof will not be repeated.

In FIG. 11, the knob 142 is located by the user in a position outside of the bar 144 and within the region 143. In FIG. 11, the pop-out amount set by the knob 142 is inapplicable to the size of the three-dimensional image 132 displayed on the monitor 114 and applicable to the size of the three-dimensional image as printed.

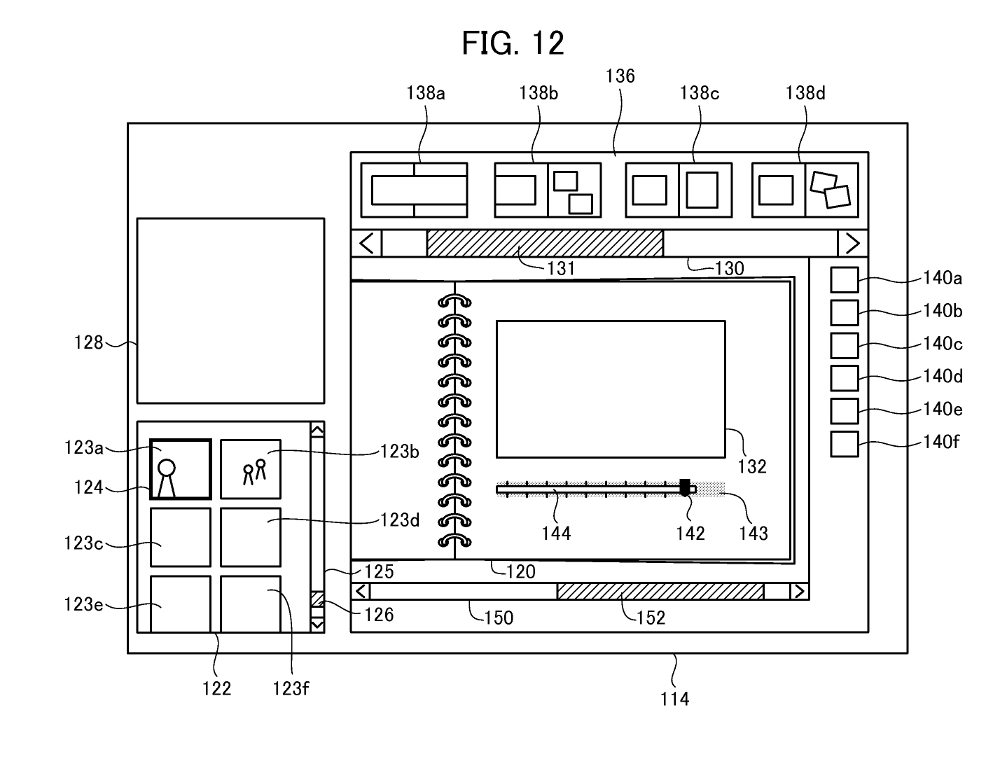

Thus, when the user sets a pop-out amount inapplicable to the size of a displayed three-dimensional image and applicable to the size of the three-dimensional image as printed, the three-dimensional image editing device 100 displays the three-dimensional image 132, the knob 142, the region 143, and the bar 144 placed in the template image 120, and the template image 120 on an enlarged scale as illustrated in FIG. 12. They are all enlarged at the same ratio.

As the three-dimensional image 132, the knob 142, the region 143, the bar 144, and the template image 120 are displayed on an enlarged scale, a new scroll bar 150 and a new knob 152 are displayed. The template image 120 moves left and right as the knob 152 is moved left and right, locating a portion outside of the display screen of the monitor 114 inside.

Since the allowable pop-out amount range widens as the size of a three-dimensional image increases, the allowable pop-out amount range for the three-dimensional image 132 widens as the three-dimensional image 132 is displayed on an enlarged scale. As the size of the three-dimensional image 132 increases and the allowable pop-out amount range widens, the length of the bar 144 becomes longer to show an allowable pop-out amount range corresponding to the size of the enlarged three-dimensional image 132.

The three-dimensional image 132 displayed in the monitor 114 can be enlarged to an extent to which the pop-out amount, indicated by the position of the knob 142, can be increased. The pop-out amount of the enlarged three-dimensional image 132 is automatically set to a pop-out amount indicated by the knob 142. Such control enables observation of a pop-out amount that is only applicable to the three-dimensional image to be printed with the three-dimensional image 132 displayed on the monitor 114. Thus, the user does not feel discomfort about the pop-out amount of a three-dimensional image displayed on the monitor 114 and the pop-out amount of the three-dimensional image as printed.

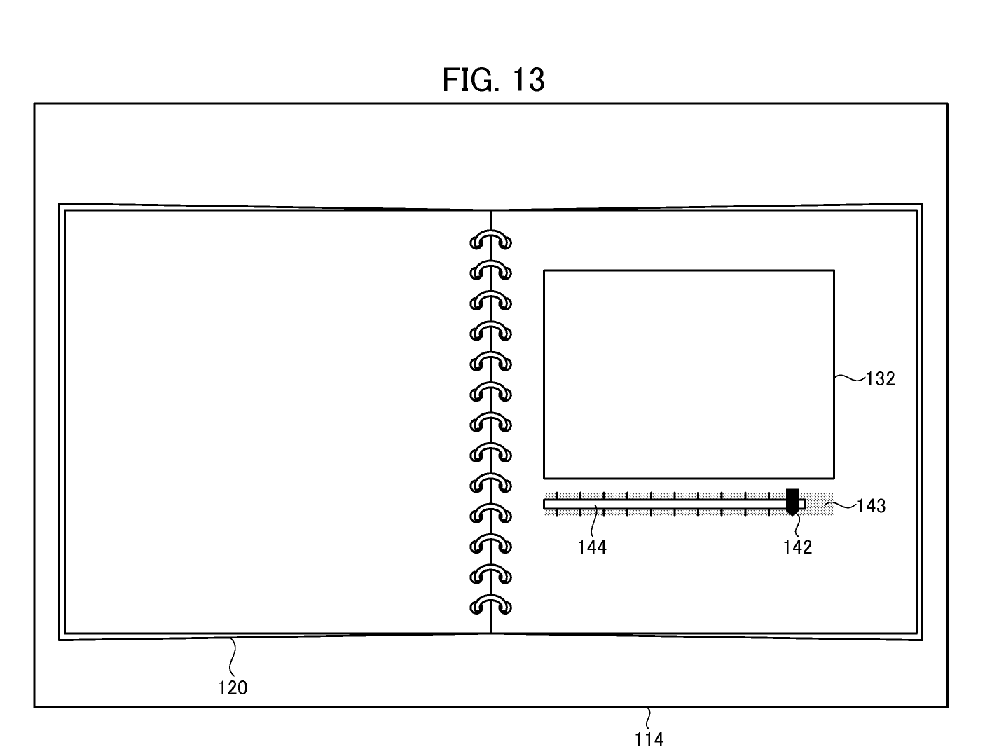

Suppose that the user moves the knob 142 farther to the right in FIG. 12 to locate the knob 142 in a position outside the bar 144 and within the region 143. Thus, when the user sets a pop-out amount that is outside of the allowable pop-out amount range for the three-dimensional image 132 as enlarged, the three-dimensional image editing device 100 displays the three-dimensional image 132, the knob 142, the region 143, and the bar 144 placed in the template image 120, and the template image 120 full-screen in the monitor 114 as illustrated in FIG. 13.

By such control whereby the three-dimensional image 132, the knob 142, the region 143, the bar 144, and the template image 120 is displayed full-screen in the monitor 114, the size of the three-dimensional image 132 becomes still larger than in FIG. 12, while the allowable pop-out amount range for the three-dimensional image 132 also widens accordingly. As the size of the three-dimensional image 132 increases and the allowable pop-out amount range widens accordingly, the length of the bar 144 becomes longer to show an allowable pop-out amount range corresponding to the size of the three-dimensional image 132 as enlarged.

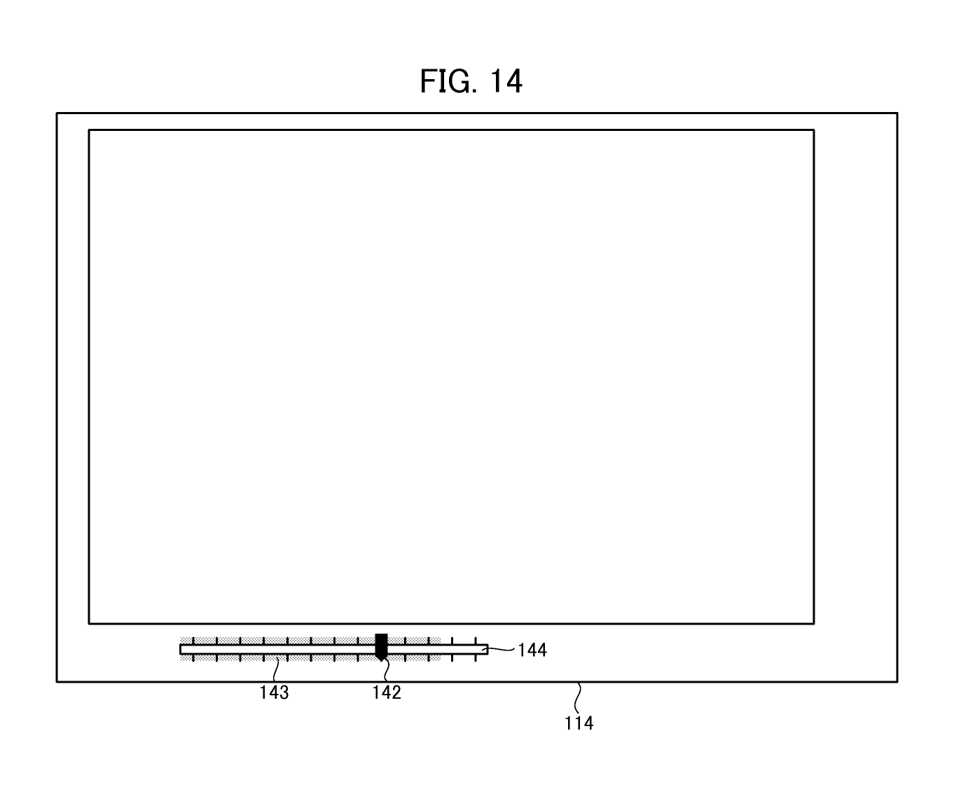

Suppose that the user moves the knob 142 farther to the right in FIG. 13 to locate the knob 142 in a position outside the bar 144 and within the region 143. Thus, when the user sets a pop-out amount that is outside of the allowable pop-out amount range for a three-dimensional image having this size, the three-dimensional image editing device 100 displays the three-dimensional image 132, the knob 142, the region 143, and the bar 144 placed in the template image 120 full-screen in the monitor 114 as illustrated in FIG. 14.

By such control whereby the three-dimensional image 132, the knob 142, the region 143, and the bar 144 is displayed full-screen in the monitor 114, the size of the three-dimensional image 132 becomes still larger than in FIG. 13, while the allowable pop-out amount range for the three-dimensional image 132 widens to a maximum range possible. As the size of the three-dimensional image 132 increases and the allowable pop-out amount range widens, the length of the bar 144 becomes longer accordingly to show an allowable pop-out amount range for the enlarged size of the three-dimensional image 132.

Thus, when the size of a three-dimensional image for printing is larger than the size of the three-dimensional image for display, a control whereby the three-dimensional image is enlarged, in other words, a control whereby the allowable pop-out amount range for the size of the three-dimensional image for display is increased when a pop-out amount inapplicable to the size of the three-dimensional image 132 for display on the monitor 114 and applicable to the size of the three-dimensional image for printing, ensures that the set pop-out amount is in a range common to the allowable pop-out amount range applicable to the size of the three-dimensional image displayed on the monitor 114 and the allowable pop-out amount range applicable to the size of the three-dimensional image for printing. Thus, the user can adjust the pop-out amount by observing on the monitor 114 the pop-out amount of the three-dimensional image to be printed.

As described above, according to the embodiment 1 of the three-dimensional image editing device 100, the allowable pop-out amount range for the size of a three-dimensional image for printing is calculated based on the size of the three-dimensional image to be printed, while the allowable pop-out amount range for the size of a three-dimensional image for display is calculated based on the size of the three-dimensional image for display. Further, according to the three-dimensional image editing device 100, the calculated allowable pop-out amount range is displayed on the monitor 114. Thus, the user can edit a three-dimensional image by viewing the allowable pop-out amount range for the three-dimensional image to be printed on the monitor 114.

Further, the three-dimensional image editing device 100 is capable of limiting the range within which the user can adjust the pop-out amount to within the allowable pop-out amount range for a displayed three-dimensional image or within the allowable pop-out amount range for the three-dimensional dimensional image to be printed. Further, the three-dimensional image editing device 100 is capable of displaying a warning when a set pop-out amount is only applicable to one of a three-dimensional image as displayed or the three-dimensional image as printed. Thus, the user knows that the pop-out amount for a three-dimensional image to be printed may not be as intended.

Further, when setting a pop-out amount inapplicable to a three-dimensional image to be printed is made impossible, the user can be precluded from mistakenly setting a pop-out amount inapplicable to a three-dimensional image to be printed.

Further, when a control is effected whereby the three dimensional image displayed on the monitor 114 is enlarged when the user sets a pop-out amount that is only applicable to the size of a three-dimensional image as printed, the pop-out amount that could otherwise be applicable only to the three-dimensional image as printed can be made applicable also to the three-dimensional image displayed on the monitor 114. This enables the user to observe the pop-out amount that could otherwise only be applicable to the size of a three-dimensional image as printed.

Although the above embodiment is described referring to a case, by way of example, where the template image is a double-spread image, the template image is not limited thereto. The template image may be, for example, a single-page template image.

Although the above embodiment is described referring to a case involving adjustment of the size and the pop-out amount of a three-dimensional image by way of example, the present invention need not necessarily be used to edit a photograph album, and the output medium need not necessarily be a print. The present invention may be used in any application where the size of a three-dimensional image in the output medium differs from the size of the three-dimensional image as of the time of editing. For example, the present invention may be used to edit a three-dimensional image in a case where the size of a display device used to edit the three-dimensional image differs from the size of a display device used to output the edited three-dimensional image and thus the size of the displayed three-dimensional image changes between before and after output. Specifically, the present invention may be used to edit a three-dimensional image on one portable terminal such as a portable phone and transmit the edited image to another portable terminal. In such case, information on the display size at the portable terminal to which the edited image is transmitted is acquired by communication or through an input by the user to calculate an allowable pop-out amount range for the output device. The present invention may also be used to edit a three-dimensional movie on, for example, a personal computer.

Since the pop-out amount of a printed three-dimensional image cannot be adjusted, viewing a three-dimensional image on, for example, a display is essential to setting, for example, a pop-out amount and a size of a three-dimensional image. In this case, the size of a three-dimensional image shown on the display does not always agree with the size of the three-dimensional image as printed. A case may therefore arise where the pop-out amount of a three-dimensional image to be printed is set by observing the three-dimensional image having a pop-out amount that is different from the allowable pop-out amount range for the three-dimensional image to be printed. However, it is difficult for the user to set a pop-out amount by determining, based on an assumption, whether a pop-out amount is applicable to the size of a three-dimensional image to be printed. Therefore, the present invention may be suitably used particularly in cases where the pop-out amount of a three-dimensional image to be printed is set, for example, by observing the image on a display.

Where a three-dimensional image is edited using a monitor having a screen larger than the size of the three-dimensional image to be printed, a mode may be used wherein the displayed three-dimensional image has the same size as the three-dimensional image to be printed. When a displayed three-dimensional image has the same size as the three-dimensional image to be printed, the allowable pop-out amount range for the three-dimensional image to be printed agrees with the allowable pop-out amount range for the three-dimensional image displayed on the monitor. Thus, the user can adjust the pop-out amount of a three-dimensional image only within the allowable pop-out amount range for the size of the three-dimensional image to be printed.

while the above embodiment uses warning marks having different figures between a case where the pop-out amount of a three-dimensional image to be printed differs from the pop-out amount of the three-dimensional image as displayed and a case where the pop-out amount of a displayed three-dimensional image is not applicable to the three-dimensional image to be printed, the figures of the warning marks need not necessarily be different. The same warning mark may be displayed for both cases or only the color thereof may be different. Further, the warning mark may have a different figure from those shown in the above embodiment.

Although a maximum displacement that can be effected is 5% of the lateral length of a three-dimensional image in the above embodiment, it need not necessarily be 5%. For example, a maximum displacement enabling depth perception varies with the distance between the eyes of a human viewing a three-dimensional image.

Although a case where the template image 120 and the images placed in the template image 120 shown in FIGS. 11 to 14 are enlarged in an order in the above embodiment, enlargement need not necessarily be effected in this order. For example, when a pop-out amount inapplicable to a displayed three-dimensional image, a control may be effected so that the editing screen illustrated in FIG. 11 is switched to a full-screen display of the three-dimensional image illustrated in FIG. 14.

Although a scroll bar is used to adjust the pop-out amount according to the above embodiment, the interface used to adjust the pop-out amount is not limited thereto. For example, the +/− button may be used, numerals may be entered directly, or three values, large, middle, and small, may be selected from a drop-down list.

Although the allowable pop-out amount range for a three-dimensional image to be printed is shown by a region, which is represented by shading in the drawing, in the above embodiment, the allowable pop-out amount range for a three-dimensional image to be printed may be shown by any other method as appropriate. A graduated bar, for example, like the bar 144 may be used to indicate the range.

In the above description of the embodiment of the invention, the internal memory 102 for storing the image data and the print size storage memory 113 for storing the print sizes are described as separate memories, but there need not necessarily be provided two memories to store such data. A single memory may be adapted to store the image data and the print sizes.

When a set pop-out amount is outside of the adjustment range common to the allowable pop-out amount range for the size of a three-dimensional image displayed on the monitor 114 and the allowable pop-out amount range for the size of the three-dimensional image to be printed, the image display controller 110 may cause the monitor 114 to display a warning prompting a change of the size of the three-dimensional image displayed on the monitor 114. In this case, it is preferable to suggest an image size that permits a pop-out amount to be set within the common adjustment range.

When a set pop-out amount is outside of the common adjustment range, the image display controller 110 may cause the monitor 114 to display a warning prompting a change of the size of the three-dimensional image to be printed. In this case, it is preferable to suggest a print size that permits a pop-out amount to be set within the common adjustment range.

When a set pop-out amount is outside of the common adjustment range, the image display controller 110 may cause the monitor 114 to display a warning prompting a replacement of the three-dimensional image being edited. In this case, it is preferable to select another three-dimensional image having a composition similar to that of the three-dimensional image being edited and which produces an increased sense of depth than the three-dimensional image being edited.

The pop-out amount adjuster 108 may collectively adjust the pop-out amounts of a plurality of three-dimensional images to the same pop-out amount. In this case, the pop-out amount adjustment range is preferably an adjustment range common to the allowable pop-out amount ranges for all the three-dimensional images of which the pop-out amounts are adjusted collectively to the same amount, or preferably limited to a common adjustment range. The pop-out amount adjustment range may be, for example, the pop-out amount adjustment range for a smallest three-dimensional image.

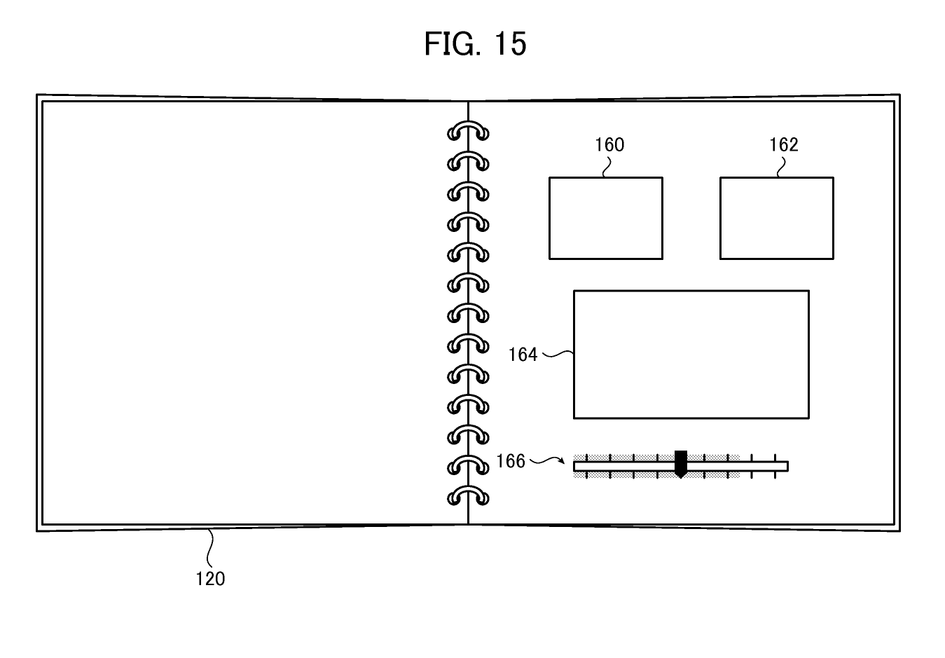

FIG. 15 illustrates an example where a scroll bar 166 is provided to set a pop-out amount to which the pop-out amounts of all the three-dimensional images, three-dimensional images 160, 162, and 164 in the illustrated example, in each page of a photograph album containing a plurality of pages are adjusted by page collectively. In this case, when the user sets a pop-out amount with the scroll bar 166 provided in the page, the pop-out amount adjuster 108 adjust the pop-out amounts of all the three-dimensional images 160, 162, and 164 contained in that page collectively to a pop-out amount set by the user.

Thus, collectively adjusting the pop-out amounts by page of a photograph album produces consistency in pop-out amount among the plurality of three-dimensional images contained in the same page and provides improved ease in viewing.

The pop-out amounts of three-dimensional images that may be collectively adjusted to one pop-out amount need not be limited to the pop-out amounts of the three-dimensional images contained in a single page of the photograph album as in the above example; for example, the pop-out amounts of all the three-dimensional images contained in the photograph album or of a plurality of three-dimensional images contained in double-page spread, or a plurality of three-dimensional images contained within a given region in a single page or double-page spread may also be collectively adjusted to one pop-out amount.

Said given region may be, for example, the upper half region or the lower half region of a single page or double-page spread, a predetermined fixed region, or any region designated by the user through the user input unit 116.

When the pop-out amounts of a plurality of three-dimensional images are collectively adjusted as described above, and when the pop-out amount adjustment range is a common adjustment range within which the pop-out amount is applicable to all the three-dimensional images of which the pop-out amounts are to be collectively adjusted, the pop-out amount range that can be set is limited. For example, when the user desires to set a great pop-out amount for a three-dimensional image, but that pop-out amount exceeds the upper limit of the pop-amount adjustment range for another three-dimensional image, making it impossible to set such a pop-out amount.

Thus, when a great pop-out amount is set for a three-dimensional image within its allowable pop-out amount range and when collective adjustment of the pop-out amounts would cause the pop-out amount of another three-dimensional image to exceed its allowable pop-out amount range, a region having a great pop-out amount, for example, may be clipped from the three-dimensional image having a pop-out amount exceeding the allowable pop-out amount range. When a region where the pop-out amount is great is clipped from a three-dimensional image, the pop-out amount of the remaining region or the whole three-dimensional image left after clipping may be reduced to a small amount.

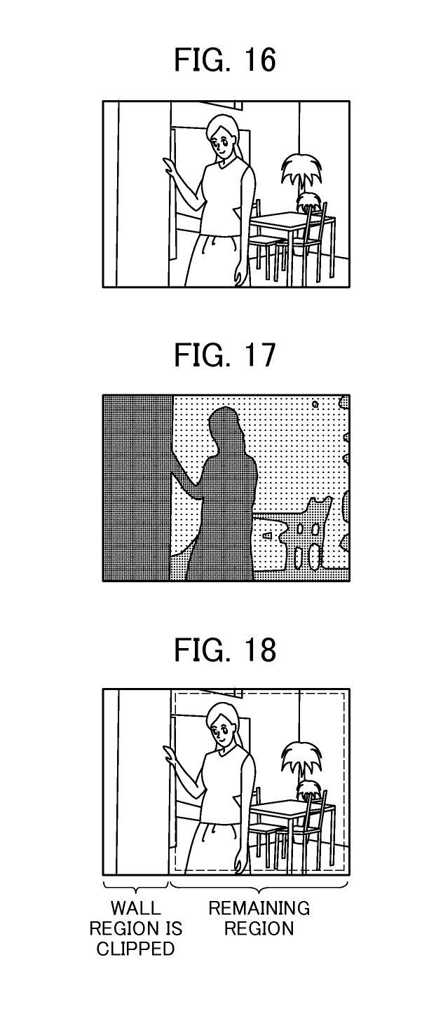

FIGS. 16 and 17 illustrate a three-dimensional image and a parallax map thereof. The parallax map illustrated in FIG. 17 visualizes the parallax between the pixels respectively corresponding to the right eye image and the left eye image of the three-dimensional image shown in FIG. 16. The parallax map is represented in, for example, simulated colors or gray scale according to the parallax; for example, pixels with the greatest parallax are represented in red, pixels with the smallest parallax are represented in blue, and pixels lying between them in the degree of parallax are represented in the intermediate color between red and blue.

It appears from the parallax map shown in FIG. 17 that the parallax of the three-dimensional image illustrated in FIG. 16 gradually decreases from a region representing the wall adjacent the left-hand side of the image, where the parallax is greatest, through a region representing the person in the middle to a region representing the background against which the person stands. The parallax of a three-dimensional image increases as the distance from the imaging device to a subject decreases, and the pop-out amount increases with the parallax. Therefore, in the three-dimensional image shown in FIG. 16, the pop-out amount is greatest in the region representing the wall.

Therefore, when the setting of the pop-out amount of a three-dimensional image is increased in order to increase the pop-out amount of the three-dimensional image and when the collective adjustment of the pop-out amounts causes the pop-out amount of the three-dimensional image shown in FIG. 16 to exceed the upper limit, clipping the region representing the wall where the pop-out amount is greatest in the three-dimensional image shown in FIG. 16 enables the pop-out amount of the remaining region, i.e., the whole three-dimensional image left after clipping as shown in FIG. 18 by a dotted line, to be reduced to a small amount.

The pop-out amount of a three-dimensional image may be reduced not only by clipping a part of the three-dimensional image but by, for example, reducing the size of the three-dimensional image displayed on the screen 114. That is, reducing the size of the three-dimensional image displayed on the monitor 114 reduces the parallax, and a reduced parallax in turn enables the pop-out amount of the three-dimensional image to be held to a small amount.

Note that the present invention is not limited to a photograph album, which is but an example taken in the above embodiment to illustrate an application of the present invention and may be also applied to various kinds of image contents comprising a plurality of pages, such as a calendar.

The device according to the above embodiment is mainly configured by a central processing unit (CPU) and software for causing the CPU to execute various kinds of processing but may alternatively be configured by digital circuits or analog circuits. The software is stored in an internal memory, which is not shown.

A program for operating a computer to perform the respective functions of the three-dimensional image editing device of which a preferred embodiment of the invention is described above, i.e., a program for causing a computer to implement the functions of the three-dimensional image editing device of the invention, a program for causing a computer to function as individual means of the three-dimensional image editing device of the invention, or a program for causing a computer to implement the steps of the three-dimensional image editing method of the invention as a procedure, is also an embodiment of the present invention. Further, a computer readable recording medium on which such program is recorded is also an embodiment of the present invention.

The embodiment of the invention described above only illustrates examples of the invention and does not limit the configuration of the invention in any manner. The three-dimensional image editing device of the invention and the three-dimensional image editing method are not limited to the above embodiment and may be modified or implemented in various manners without departing from the spirit and scope of the invention.

Where the monitor 114 is constituted by a touch panel, for example, the operation performed using, for example, the mouse of the user input unit 116 described above may be performed with, for example, the user's finger.

The three-dimensional image editing device and the three-dimensional image editing method of the invention may also be used to edit a three-dimensional image to be printed and to edit a three-dimensional movie, and may also be used in, for example, digital cameras.

1. A three-dimensional image editing device for editing a three-dimensional image displayed on a monitor and outputting the three-dimensional image to an output medium other than the monitor, the three-dimensional image editing device comprising:
a calculation unit for calculating a first adjustment range, which is an allowable pop-out amount range for a first size of the three-dimensional image displayed on the monitor and calculating a second adjustment range, which is an allowable pop-out amount range for a second size of the three-dimensional image outputted to the output medium, and
an adjustment unit for adjusting a pop-out amount of the three-dimensional image being edited based on the first adjustment range and the second adjustment range.

2. The three-dimensional image editing device according to claim 1 further comprising a display control unit for causing the monitor to display the first adjustment range and the second adjustment range simultaneously.

3. The three-dimensional image editing device according to claim 2 further comprising an input unit for inputting a setting of a pop-out amount of the three-dimensional image being edited within the first adjustment range or the second adjustment range.

4. The three-dimensional image editing device according to claim 3, wherein when a pop-out amount that is outside of a common adjustment range common to the first adjustment range and the second adjustment range is set, the adjustment unit adjusts the pop-out amount of the three-dimensional image being edited to within the common adjustment range.

5. The three-dimensional image editing device according to claim 3, wherein the adjustment unit makes a different adjustment depending on which of the first size and the second size is larger.

6. The three-dimensional image editing device according to claim 5, wherein when the first adjustment range does not coincide with the second adjustment range, the adjustment unit adjusts the pop-out amount of the three-dimensional image being edited to within a common adjustment range common to the first adjustment range and the second adjustment range.

7. The three-dimensional image editing device according to claim 5, wherein when the second size is smaller than the first size, the adjustment unit limits an input range for setting the pop-out amount to within the second adjustment range.

8. The three-dimensional image editing device according to claim 5, further comprising an enlargement unit which, when the first size is smaller than the second size and when the pop-out amount outside of a common adjustment range common to the first adjustment range and the second adjustment range is set, enlarges a size of the three-dimensional image being edited so that a pop-out amount adjusted by the adjustment unit is contained within the first adjustment range.

9. The three-dimensional image editing device according to claim 3, wherein when a pop-out amount that is outside of a common adjustment range common to the first adjustment range and the second adjustment range is set, the display control unit causes the monitor to give a warning.

10. The three-dimensional image editing device according to claim 9, wherein the display control unit causes the monitor to give a warning prompting a change of the first size.

11. The three-dimensional image editing device according to claim 9, wherein the display control unit causes the monitor to give a warning prompting a change of the second size.

12. The three-dimensional image editing device according to claim 9, wherein the display control unit causes the monitor to give a warning prompting a replacement of the three-dimensional image being edited.

13. The three-dimensional image editing device according to claim 1, wherein the adjustment unit collectively adjusts pop-out amounts of a plurality of the three-dimensional images to a same pop-out amount.

14. The three-dimensional image editing device according to claim 13, wherein the adjustment unit collectively adjusts the pop-out amounts of the plurality of the three-dimensional dimensional images in response to a setting of a pop-out amount contained within a pop-out amount adjustment range for a smallest three-dimensional image.

15. The three-dimensional image editing device according to claim 13, wherein when a pop-out amount of a second three-dimensional image exceeds a pop-out amount adjustment range for the second three-dimensional image as the pop-out amount is set to a great value within a pop-out amount adjustment range for a first three-dimensional image, a region in the second three-dimensional image having a great pop-out amount is clipped from the second three-dimensional image to reduce a pop-out amount of a region of the second three-dimensional image that remains after the region having a great pop-out amount has been clipped.

16. The three-dimensional image editing device according to claim 13, wherein the adjustment unit collectively adjusts pop-out amounts of a plurality of the three-dimensional images arranged in a plurality of pages of an image content.

17. The three-dimensional image editing device according to claim 16, wherein the adjustment unit collectively adjusts one of pop-out amounts of all the three-dimensional images contained in the image content, pop-out amounts of a plurality of the three-dimensional images contained in a single page, pop-out amounts of a plurality of the three-dimensional images contained in a double-page spread, pop-out amounts of a plurality of the three-dimensional images contained within a given region from among a plurality of the three-dimensional images placed in the single page or the double-page spread.

18. A three-dimensional image editing method of editing a three-dimensional image displayed on a monitor and outputting the three-dimensional image to an output medium other than the monitor, the three-dimensional image editing method comprising:
a calculation step of calculating a first adjustment range, which is an allowable pop-out amount range for a first size of the three-dimensional image displayed on the monitor and calculating a second adjustment range, which is an allowable pop-out amount range for a second size of the three-dimensional image outputted to the output medium, and
an adjustment step of adjusting a pop-out amount of the three-dimensional image being edited based on the first adjustment range and the second adjustment range.

19. A non-transitory computer readable recording medium for recording a three-dimensional image editing program for causing the computer to execute the steps of a three-dimensional image editing method for editing a three-dimensional image displayed on a monitor and outputting the three-dimensional image to an output medium other than the monitor, comprising:
a calculation step of calculating a first adjustment range, which is an allowable pop-out amount range for a first size of the three-dimensional image displayed on the monitor and calculating a second adjustment range, which is an allowable pop-out amount range for a second size of the three-dimensional image outputted to the output medium, and
an adjustment step of adjusting a pop-out amount of the three-dimensional image being edited based on the first adjustment range and the second adjustment range.
